(19) United States
(12) Patent Application Publication
(10) Pub. No.: US 2007/0192313 A1
(43) Pub. Date: Aug. 16, 2007

(54) Data search method with statistical analysis performed on user provided ratings of the initial search results

(76) Inventors: William Derek Finley, Ottawa (CA); Christopher William Doylend, Ottawa (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 11/698,887

(22) Filed: Jan. 29, 2007

Related U.S. Application Data
(60) Provisional application No. 60/762,514, filed on Jan. 27, 2006.

(51) Int. Cl. G06F 17/30

(52) U.S. Cl. 707/5

(57) ABSTRACT

A method of searching for content that is stored on a computer system includes receiving a plurality of initial search results based on an initial search query. At least some initial search results of the plurality of initial search results are rated according to a predetermined criterion. First data relating to the rating of the at least some initial search results is provided, and a final search result is returned, based on a correlation between the first data and communal data that is stored on the computer system. Content associated with the final search result is access, the content also being stored on the computer system.

This application claims the benefit of U.S. Provisional Application 60/762,514, filed on Jan. 27, 2006, the entire contents of which are incorporated herein by reference.

### FIELD OF THE INVENTION

The instant invention relates generally to data searching, and more particularly to a method for ranking web search results according to a user's current interest.

### BACKGROUND

Web search engines work by storing information about a large number of web pages, which they retrieve from the World Wide Web itself. These pages are retrieved by the use of a Web crawler (sometimes also known as a spider)—an automated Web browser that follows every link it sees. Exclusions can be made by the use of robots.txt. The contents of each page are then analyzed to determine how it should be indexed; for example, words are extracted from the titles, headings, or special fields called meta tags. Data about web pages are stored in an index database for use in later queries. Some search engines, such as GOOGLE™, store all or part of the source page (referred to as a cache) as well as information about the web pages, whereas others, such as ALTAVISTA™, store every word of every page they find. This cached page always holds the actual search text since it is the one that was actually indexed, so it can be very useful when the content of the current page has been updated and the search terms are no longer in it. This problem might be considered to be a mild form of linkrot, and GOOGLE's handling of it increases usability by satisfying user expectations that the search terms will be on the returned web page. This satisfies the principle of least astonishment since the user normally expects the search terms to be on the returned pages. Increased search relevance makes these cached pages very useful, even beyond the fact that they may contain data that may no longer be available elsewhere.

When a user comes to the search engine and makes a query, typically by giving key words, the engine looks up the index and provides a listing of best-matching web pages according to its criteria, usually with a short summary containing the document's title and sometimes parts of the text. Most search engines support the use of the Boolean terms AND, OR and NOT to further specify the search query. An advanced feature is proximity search, which allows users to define the distance between keywords.

The usefulness of a search engine depends on the relevance of the result set it gives back. While there may be millions of web pages that include a particular word or phrase, some pages may be more relevant, popular, or authoritative than others. Most search engines employ methods to rank the results to provide the “best” results first. How a search engine decides which pages are the best matches, and what order the results should be shown in, varies widely from one engine to another. The methods also change over time as Internet usage changes and new techniques evolve.

Most Web search engines are commercial ventures supported by advertising revenue and, as a result, some employ the controversial practice of allowing advertisers to pay money to have their listings ranked higher in the search results. Those search engines that do not accept money for their search engine results make money by running search related ads alongside the regular search engine results. The search engines make money every time someone clicks on one of these ads.

One problem with the prior art approach to ranking search engine results is that the ranking is performed entirely independent of the searcher's interest. If the initial search results list consist of 1,000,000 results, and the searcher's interest is not relatively mainstream, then the searcher is forced either to scroll through page after page of results, manually investigating each result that appears to be of interest, or reformulate a narrower search in the hope of excluding the extraneous results. The former solution is time consuming, and frustrating especially if web pages take a long time to load and then turn out to be of no interest, whilst the second solution may result in certain important results being overlooked if the search is not formulated very precisely. It would be quite beneficial to have the ability to rank the search results differently for different user, based on each different user's actual interests.

It would be advantageous to provide a method for analyzing and/or visualizing highly correlated data sets that overcomes at least some of the above-mentioned limitations of the prior art.

### SUMMARY OF EMBODIMENTS OF THE INSTANT INVENTION

According to an aspect of the instant invention there is provided a method of searching for content that is stored on a computer system, comprising: receiving a plurality of initial search results based on an initial search query, the plurality of initial search results relating to content that is stored on the computer system; according to a predetermined criterion, rating at least some initial search results of the plurality of initial search results; providing first data relating to the rating of the at least some initial search results; receiving a final search result based on a correlation between the first data and communal data that is stored on the computer system, the communal data based on a correlation index of different results within a search space; and, accessing content associated with the final search result, the content being stored on the computer system.

According to an aspect of the instant invention there is provided a method of providing content that is stored on a computer system, comprising: providing a plurality of initial search results based on an initial search query of a first user of the computer system, the plurality of initial search results relating to content that is stored on the computer system; receiving first data relating to a rating of the at least some initial search results by the first user, the rating performed according to a predetermined criterion; correlating the first data with communal data that is stored on the computer system, the communal data relating to ratings of the at least some initial search results provided previously by a plurality of users of the computer system, in association with the same initial search query; determining users of the plurality of users of the computer system having associated therewith data relating to ratings of the at least some initial search results that correlate with the first data to within a predetermined threshold limit; based on known final search results selected by each of the determined users in association with the same initial search query, determining a statistically most significant final search result; and, providing the statistically most significant final search result to the first user for accessing content associated therewith.

According to an aspect of the instant invention there is provided a computer-readable storage medium having stored thereon computer-executable instructions for performing a method of searching for content that is stored on a computer system, the method comprising: providing a plurality of initial search results based on an initial search query of a first user of the computer system, the plurality of initial search results relating to content that is stored on the computer system; receiving first data relating to a rating of the at least some initial search results by the first user, the rating performed according to a predetermined criterion; correlating the first data with communal data that is stored on the computer system, the communal data relating to ratings of the at least some initial search results provided previously by a plurality of users of the computer system, in association with the same initial search query; determining users of the plurality of users of the computer system having associated therewith data relating to ratings of the at least some initial search results that correlate with the first data to within a predetermined threshold limit; based on known final search results selected by each of the determined users in association with the same initial search query, determining statistically most significant final search result; and, providing the statistically most significant final search result to the first user for accessing content associated therewith.

### BRIEF DESCRIPTION OF THE DRAWINGS

Exemplary embodiments of the invention will now be described in conjunction with the following drawings, in which similar reference numerals designate similar items:

FIG. 1 is a simplified flow diagram for a method according to an embodiment of the instant invention; and,

FIG. 2 is a simplified flow diagram for a method according to another embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

Herein and in the claims that follow, the term correlation index is used to refer to an indication of correlation between different entries. One such correlation index is based on communal data provided by user of a system. Another such correlation index is automatically generated based on an analysis of the different entries. Advantageously, a correlation index is useful in evaluating a correlation between entries. Entries, as used here refers to entries within a database, list, World Wide Web pages, articles, BLOGS, etc.

Methods according to the various embodiments of the instant invention are intended for use with computer systems, such as for instance the Internet of the World Wide Web. The Internet is a widely distributed computer system, including a vast network of computers and file servers that are located in virtually every country on the planet. Although the Internet started out being rather limited in its application, by virtue of relating mainly to highly specialized content of a technical nature and therefore being of interest mainly to the academic and scientific community, today its applications include on-line shopping, financial transactions, virtual diary spaces (web logs or BLOGS), and providing encyclopedic access to information that is of general interest to varied types of individuals and organizations. Furthermore, the continually increasing affordability of computer hardware coupled with improvements in access to high speed residential data transfer systems has resulted in a veritable explosion of use of the Internet over the last several years. The Internet currently enjoys much more widespread appeal, and as a result the individuals that are accessing the Internet now represent a much more demographically diverse group of people.

Unfortunately, with increasing user diversity certain problems have begun to emerge. Firstly, a tremendous amount of information covering a wide variety of topics and areas of interest is being stored every day, which increases the total amount of searchable information, and often frustrates efforts to find precisely the information that is needed at a specific time. Secondly, typically different individuals are interested in different types of information, even when the search strings they provide are very similar or identical. Even if personal or demographic information relating to an individual user is available, nevertheless that user's interests change with time. Furthermore, the type of information a particular user is interested in may depend heavily on how the user intends to make use of that information. Accordingly, due to the diversity of different users and even the diversity of a same user's interests, a user's ability to find precisely the information that is needed at any particular point in time has depended partly on luck and party on the user's perseverance.

According to an embodiment of the instant invention a user provides an initial search query via a search engine interface, and the search engine looks up the index and provides a listing of best-matching web pages ranked according to known criteria, usually with a short summary containing the web document's title and sometimes parts of the text. Optionally, the criteria are based on personal information relating to the user, demographic information relating to the user, or are based on an analysis of past searches performed by the user. Of course, other criteria optionally are used.

Having now a list of best-matching web pages, ranked according to some known criteria of the search engine, the user then rates some of the results according to their interest in the content of the associated web pages. For instance, the user accesses the top five web pages and surveys quickly the content of each web page. The user then assigns each web page to a rating category, for example as one of “not relevant,” “relevant” or “unknown.” Optionally, more categories are available, such as for instance “somewhat relevant” or “not at all relevant.” By extension, any number of categories may be used for the purpose of rating. Optionally, the number of categories is selectable based on the user's own comfort and/or experience rating web page content and/or the amount of search result refinement desired. Optionally, each web page is rated between two numerical values, such as for instance a rating between 1 and 10 or a rating between 1 and 5, either the upper range value or the lower range value relating to highest interest, etc. Furthermore, the number of web pages that are rated by the user optionally is greater than or less than 5. Alternatively, the best-matching web page results, provided as a ranked list, include a check box for indicating relevance. Accordingly, the user optionally reads the brief summary or accesses the actual web page and decides whether the result is relevant. If the user determines the result to be relevant, the check box is selected. If the user determines the result not to be relevant, the check box is left empty. In this way, the user optionally scans quickly down the initial result list selecting the relevant results as they go, and optionally revisiting earlier selections if it becomes apparent that other results are more relevant. The user selects at least one check box from the list of initial results, and optionally the user is allowed to select up to a predetermined maximum number of relevant results (i.e. 5 or 10, etc.), or the user is allowed to select the number of relevant results that they deem necessary to refine adequately the list of initial results.

Continuing this first example, once the user has rated the 5 web pages in terms of relevance to the user's interest at the current time, the user commands the search engine to refine the initial search results list. By way of a specific and non-limiting example, data relating to the user rating of the top 5 web pages is mapped onto a correlation index or similarity index, such as for instance a three-dimensional data structure relating to previous searches performed by other users. In particular, the data structure includes highly correlated communal data relating to other users' web page ratings and the results that the other users were ultimately interested in. By correlating the user's rating data for the current search with the highly correlated communal data, other data is determined that is indicative of which final result the other users that rated the web pages similarly to the user were ultimately interested in. Optionally, a reduced search result list is then produced based on the determined other data. For instance, the reduced search result list includes a plurality of results selected only from the same general area of interest as indicated by the user's web page rating. Further optionally the same results that were presented in the initial search result list are presented, but the ranking of the results now is selected to reflect the user's indicated interest. In such a personalized results list, the number of results is not decreased but the likelihood is increased that the most relevant results are near the top of the list.

Stated differently, the web page rating data provided by the user is utilized as a demographic independent gauge of the user's current interest. This is advantageous since, for instance, a female 47 year old married 4^{th} grade teacher with two children and an annual salary of $60,0000.00, during the course of preparing a science project for her class relating to the life cycle of the red eyed tree frog, actually is interested in precisely the same information as the male 8 year old single 4^{th} grade pupil with one puppy and a guppy and an annual allowance of $104.00, during the course of completing the same project. Provided both the teacher and the pupil rate the web pages of the initial search result list similarly, the same reduced search result list is presented despite the vastly different demographic profile of the two. Alternatively, the same user performing the same initial search at different times and for different reasons is necessarily presented with identical final results lists for each search. As an example, during a first search the user enters the search string “golf and club and cost and Florida” in order to determine an estimate of the cost of playing a round of golf at a club in Florida. Then during a second search the same user enters the same search string in order to determine the cost of buying a golf club at a shop in Florida. The user's interest has changed over time, but neither the search string nor the user's demographic profile has changed. Nevertheless, correlating the user's rating of the top five search results with the highly correlated communal data, relating to the other users as discussed supra, reveals that the user's interest has changed. Even though the same initial search results list is obtained for both the first search and for the second search, advantageously the reduced or personalized results list is different for the first search than it is for the second search.

Alternatively, the communal data is generated in an automated fashion based on similarities between different web pages. For instance, a web search engine such as GOOGLE constantly is “crawling” the web looking for content and building a search term database for use in performing searches. According to a process, a correlation or similarity index also is populated and updated during the normal course of crawling. The similarity index relates different web sites that are similar to each other, for instance according to defined topics. In some cases, a first web page and a second web page are flagged as similar for a first topic, such as (forensic)—(evidence)—(fingerprint)— (minutiae recognition and analysis), whilst the second web page and a third page are flagged as similar for a second topic, such as (forensic)—(evidence)—(fingerprint)— (genetic sequencing). In this example, the first web page and the third web page are not flagged as being similar. The process results in web pages being grouped together or linked according to an area of interest associated therewith. When stored in a multi-dimensional data visualization structure, the results conveniently are sorted such that the most similar results are placed closest together in a display space.

Continuing this second example, once the user has rated the 5 web pages in terms of relevance to the user's interest at the current time, the user commands the search engine to refine the initial search results list. By way of a specific and non-limiting example, data relating to the user's rating of the top 5 web pages is mapped onto the communal data of the similarity index. A refined list of search results is provided, which contains results that are associated with a particular area of interest that is similar to the user's current area of interest, as determined on the basis of the data relating to the web page ratings. Effectively, the size of the search space is reduced compared to the initial search space, so as only to include those web pages that re associated in the similarity index with the user's current area of interest.

Optionally, the process is repeated more than one time, selecting new top-rated web sites each time the list of search results is refined, so as to progressively refine the search space. Optionally, the top-rated web sites are displayed during each iteration so as to allow the user to uncheck the check box if it becomes necessary to broaden the refined list of search results, or if it is simply determined that some of the web sites are of lower relevance than was initially believed.

Advantageously, additional data optionally is stored in association with the communal data, the additional data being indicative of a rate of change of the communal data. In the case of web page ratings provided by other users, the relevance ratings given to some sites may decrease over time as new and more relevant sites are introduced. Similarly, as web crawlers update the similarity index new sites may correlate more closely with certain sites than with other sites within a same general area of interest. Accordingly, a measure of the rate at which the communal data is changing is indicative of the stability of the information, and is very useful for the purposes of refining searches especially in rapidly changing or rapidly advancing fields. The rate of change of the communal data based on other users' web page ratings and the rate of change of the communal data based on automated similarity index generation are used, according to an embodiment, to weight the extent to which each type of communal data is used to refine search results. Typically, when communal data varies rapidly, it is likely less useful than more stable communal data unless it is updated very frequently. Conversely, very stable data is likely extremely reliable. A measure of data stability, for example a derivative thereof is helpful in assessing a balance between communal data and automated similarity index generation.

A correlation index that is automatically generated is generated based on an evaluated correlation between different sites. Those sites that correlate more closely have a different correlation index than those sites that correlate less closely. In a simple case, correlation is performed by determining a percentage of words within a site that are identical. Lexical analysis is optionally performed to ensure that synonyms are equally weighted. Optionally, truncation is performed to ensure that similar words are correlated similarly. Alternatively, phrase analysis is used in the automated correlation process.

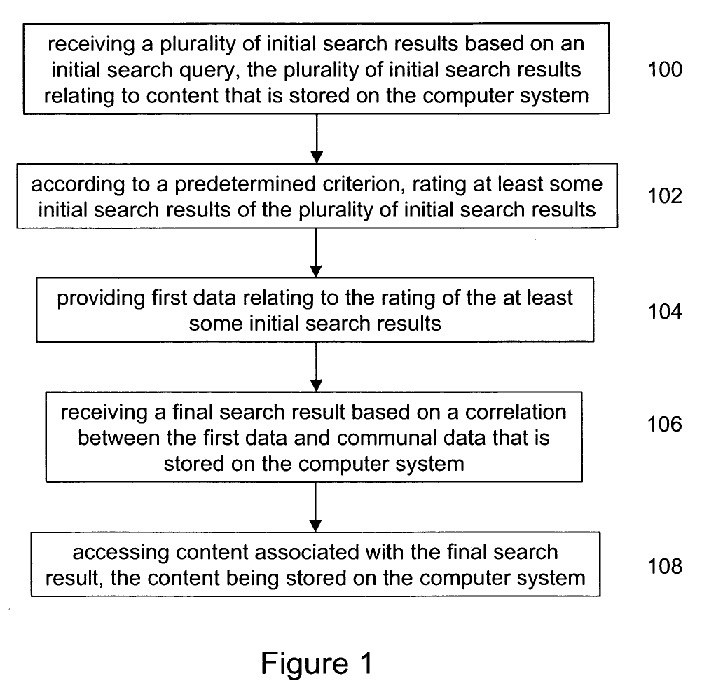

FIG. 1 is a simplified flow diagram for a method according to an embodiment of the instant invention. At step 100 a plurality of initial search results based on an initial search query is received, the plurality of initial search results relating to content that is stored on the computer system. According to a predetermined criterion, at least some initial search results of the plurality of initial search results are rated at step 102. First data relating to the rating of the at least some initial search results are provided at step 104. At step 106 a final search result is received, based on a correlation between the first data and communal data that is stored on the computer system, the communal data based on a correlation index of different results within a search space. At step 108 content associated with the final search result is accessed, the content being stored on the computer system.

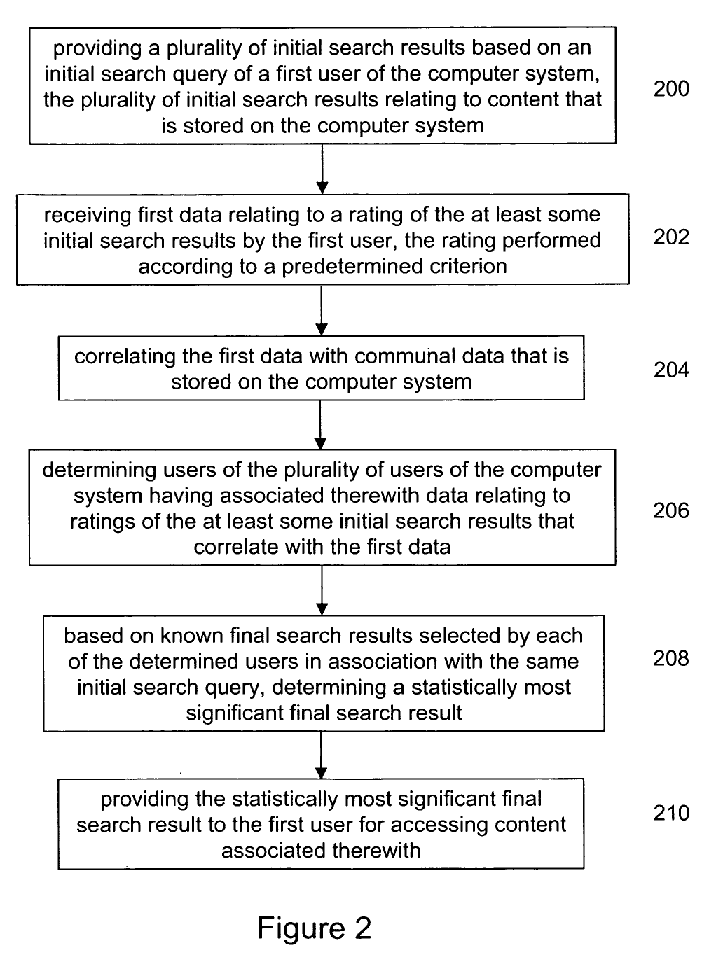

FIG. 2 is a simplified flow diagram for a method according to another embodiment of the instant invention. At step 200 a plurality of initial search results based on an initial search query of a first user of the computer system is provided. In particular, the plurality of initial search results relates to content that is stored on the computer system. At step 202, first data is received, the first data relating to a rating of the at least some initial search results by the first user, the rating performed according to a predetermined criterion. At step 204 the first data is correlated with communal data that is stored on the computer system, the communal data relating to ratings of the at least some initial search results provided previously by a plurality of users of the computer system, in association with the same initial search query. At step 206 users of the plurality of users of the computer system are determined, said users having associated therewith data relating to ratings of the at least some initial search results that correlate with the first data to within a predetermined threshold limit. At step 208, based on known final search results selected by each of the determined users in association with the same initial search query, a statistically most significant final search result is determined. At step 210 the statistically most significant final search result is provided to the first user for accessing content associated therewith.

Numerous other embodiments may be envisioned without departing from the spirit and scope of the invention.

What is claimed is:

1. A method of searching for content that is stored on a computer system, comprising:
receiving a plurality of initial search results based on an initial search query, the plurality of initial search results relating to content that is stored on the computer system;
according to a predetermined criterion, rating at least some initial search results of the plurality of initial search results;
providing first data relating to the rating of the at least some initial search results;
receiving a final search result based on a correlation index relating to the plurality of initial search results and the first data; and,
accessing content associated with the final search result, the content being stored on the computer system.

2. A method according to claim 1, wherein the correlation index relates to a three-dimensional data visualization structure.

3. A method according to claim 1 wherein the correlation index is determined in dependence upon communal data that is stored on the computer system.

4. A method according to claim 3, wherein the correlation index includes ratings of the at least some initial search results as provided previously by a plurality of users of the computer system.

5. A method according to claim 1, comprising providing the initial search query.

6. A method according to claim 5, wherein the initial search query is provided using a Web search engine.

7. A method according to claim 2, wherein the plurality of initial search results comprises initial search results that are sorted into a plurality of categories, each category represented by a different data label distributed on a surface of a three-dimensional solid shape to form a three-dimensional representation of the search results for the initial search query.

8. A method according to claim 4, wherein rating the at least some initial search results comprises accessing web page content associated with each one of the at least some initial search results and viewing at least a portion of said web page content.

9. A method according to claim 8, wherein predetermined criterion is a quantification of the user's perceived relevance to the initial search of the at least a portion of said web page content.

10. A method according to claim 1, wherein the final search result consists of a single search result.

11. A method according to claim 1, wherein the final search result comprises a plurality of final search results having a total number of results that is fewer than a number of results forming the plurality of initial search results.

12. A method according to claim 11, wherein the final search results of the plurality of final search results are displayed on a surface of a three-dimensional data visualization structure.

13. A method according to claim 1, wherein the final search result comprises a plurality of final search results including a total number of results that is at least approximately the same as the number of results forming the plurality of initial search results.

14. A method according to claim 13, wherein the plurality of final search results is ranked in an order that is different than an order of the plurality of initial search results.

15. A method according to claim 13, wherein the final search results of the plurality of final search results are displayed on a surface of a three-dimensional data visualization structure.

16. A method according to claim 1, wherein the correlation index relates to a correlation performed automatically according to a predetermined process.

17. A method according to claim 16, wherein the predetermined process comprises processing text that is associated with the content that is stored on the computer system.

18. A method of providing content that is stored on a computer system, comprising:
providing a plurality of initial search results based on an initial search query of a first user of the computer system, the plurality of initial search results relating to content that is stored on the computer system;
receiving first data relating to a rating of the at least some initial search results by the first user, the rating performed according to a predetermined criterion;
correlating the first data with communal data that is stored on the computer system, the communal data relating to ratings of the at least some initial search results provided previously by a plurality of users of the computer system, in association with the same initial search query;
determining users of the plurality of users of the computer system having associated therewith data relating to ratings of the at least some initial search results that correlate with the first data to within a predetermined threshold limit;
based on known final search results selected by each of the determined users in association with the same initial search query, determining a statistically most significant final search result; and,
providing the statistically most significant final search result to the first user for accessing content associated therewith.

19. A method according to claim 18, wherein providing the plurality of initial search results comprises sorting initial search results according to a predetermined categorization scheme so as to obtain a plurality of categorically grouped sets of initial search results.

20. A method according to claim 18, wherein providing the plurality of initial search results comprises associating a descriptive data label with each categorically grouped set of initial search results and further comprises displaying a three-dimensional representation of the search results for the initial search query, the search results comprising the descriptive data labels distributed on a surface of a three-dimensional solid shape.

21. A method according to claim 18, wherein the predetermined criterion is a quantification of the user's perceived relevance to the initial search of the at least some initial search results.

22. A method according to claim 18, wherein the final search result consists of a single search result.

23. A method according to claim 18, wherein the final search result comprises a plurality of final search results having a total number of results that is fewer than a number of results forming the plurality of initial search results.

24. A method according to claim 23, wherein the final search results of the plurality of final search results are displayed on a surface of a three-dimensional data visualization structure.

25. A method according to claim 18, wherein the final search result comprises a plurality of final search results including a total number of results that is at least approximately the same as the number of results forming the plurality of initial search results.

26. A method according to claim 25, wherein the plurality of final search results is ranked in an order that is different than an order of the plurality of initial search results.

27. A method according to claim 26, wherein the final search results of the plurality of final search results are displayed on a surface of a three-dimensional data visualization structure.

28. A computer-readable storage medium having stored thereon computer-executable instructions for performing a method of searching for content that is stored on a computer system, the method comprising:
providing a plurality of initial search results based on an initial search query of a first user of the computer system, the plurality of initial search results relating to content that is stored on the computer system;
receiving first data relating to a rating of the at least some initial search results by the first user, the rating performed according to a predetermined criterion;
correlating the first data with communal data that is stored on the computer system, the communal data relating to ratings of the at least some initial search results provided previously by a plurality of users of the computer system, in association with the same initial search query;
determining users of the plurality of users of the computer system having associated therewith data relating to ratings of the at least some initial search results that correlate with the first data to within a predetermined threshold limit;
based on known final search results selected by each of the determined users in association with the same initial search query, determining statistically most significant final search result; and,
providing the statistically most significant final search result to the first user for accessing content associated therewith.
